(19) United States
(12) Patent Application Publication
(10) Pub. No.: US 2023/0100392 A1
(43) Pub. Date: Mar. 30, 2023

(54) VARIABLE VOLUME DEVICE, SEALED TANK SYSTEM AND METHOD FOR MANUFACTURING BELLOWS

(71) Applicant: TOYODA GOSEI CO., LTD., Kiyosu-shi (JP)

(72) Inventor: Tomohiro SUGIZAKI, Kiyosu-shi (JP)

(21) Appl. No.: 17/946,126

(22) Filed: Sep. 16, 2022

(30) Foreign Application Priority Data
Sep. 30, 2021 (JP) 2021-160294

(51) Int. Cl. F04B 45/02

(52) U.S. Cl. CPC F04B 45/02

(57) ABSTRACT

A bellows includes a bellows structure portion on a tubular member. An internal space of the tubular member to an internal space of a fuel tank by the coupling port of the bellows. The bellows structure portion includes a first portion, a second portion, and a coupling portion. The first portion protrudes outward in the radial direction of the tubular member. The second portion is recessed inward in the radial direction relative to the first portion. In a cross section along the central axis of the tubular member, each of the first portion and the second portion is formed in an arc shape and the coupling portion makes the first portion couple to the second portion without any singularity. Here, the central angle of each of the first portion and the second portion of the bellows structure portion is greater than 180 degrees. With the result that the length of the bellows structure portion in the axial direction is increased over a predetermined range without the outermost diameter of the first portion and the innermost diameter of the second portion being significantly changed.

### CROSS-REFERENCE TO RELATED APPLICATION

The present application claims priority from Japanese application P2021-160294 filed on Sep. 30, 2021, the content of which is hereby incorporated by reference into this application.

### BACKGROUND

### 1. Field

The present disclosure relates to a variable volume device, a sealed tank system using such a variable volume device and a method for manufacturing a bellows.

### 2. Related Art

A fuel such as gasoline in a fuel tank may vaporize due to an environmental temperature or the like, and in order to prevent the vaporized fuel from being discharged to the atmosphere, the vaporized fuel is adsorbed to a canister or the like, is discharged from the canister when an engine or the like is operated and is utilized. There is an upper limit for the amount of fuel adsorbed to the canister, and it is likely that timing at which the adsorbed fuel is able to be utilized is limited. Hence, with consideration given to the environment, a sealed tank system is proposed which prevents the discharge of the vaporized fuel to the outside.

In the sealed tank system as described above, when the vaporization of the fuel proceeds, a pressure in the tank is increased. Hence, for example, as disclosed in Japanese Unexamined Patent Application Publication No. 2013-95338, the pressure resistance of a tank is increased or a mechanism for changing the volume of part which stores a fuel is provided, with the result that variations in pressure are suppressed. As the mechanism for changing the volume, a mechanism using a bellows structure such as a bellows is known.

However, in a normal bellows, when variations in volume are repeated, a bellows portion is repeatedly folded and extended, and stress is especially concentrated on the folded portion, with the result that there is a concern about lack of durability. With consideration given to the useful life of a fuel tank used in a vehicle and the like, it is necessary to realize sufficient durability even when an operation of changing the volume is repeated.

### SUMMARY

According to one aspect of the present disclosure, a variable volume device (50, 50A) is provided. The variable volume device (50, 50A) comprises: a bellows (60) that includes a bellows structure portion (63) on a tubular member; and a coupling port (62) that couples to an internal space of the tubular member to an internal space of a fuel tank (15). Here, the bellows structure portion (63) includes, in a cross section along a central axis of the tubular member: a first portion (71) which protrudes outward in a radial direction of the tubular member and is formed in an arc shape; a second portion (72) which is recessed inward in the radial direction relative to the first portion (71) and is formed in an arc shape; and a coupling portion (73) which makes the first portion (71) couple to the second portion (72) without any singularity, and the central angle (θ) of each of the arc shapes of the first portion (71) and the second portion (72) is greater than 180 degrees. The variable volume device (50, 50A) is able to realize the bellows (60) capable of increasing the amount of change of the internal volume and having high durability. The variable volume device (50, 50A) is used, and thus it is possible to easily realize a sealed tank system (10, 10A).

According to another aspect of the present disclosure, a method for manufacturing a bellows used for the above-mentioned variable volume device (50, 50A). The method for manufacturing the bellows includes: a step (T100) of molding the tubular member into a shape in a state where the bellows structure portion (63) is extended; a step (T120) of surrounding a predetermined area including a top of a first portion (71) of the bellows structure portion (63) by an outer ring mold (171) including a concave portion whose cross section along the center axis of the tubular member has an arc shape, the first portion (71) protruding outward in a radial direction; a step (T110) of surrounding a predetermined area including a valley of a second portion (72) of the bellows structure portion (63) by an inner ring mold (172) including a convex portion whose cross section along the center axis of the tubular member has an arc shape, the second portion (72) being recessed inward in the radial direction relative to the first portion (71); a step (T140) of bringing the tubular member into a plastically deformable first state and compressing the bellows structure portion (63) in a direction in which the outer ring mold (171) and the inner ring mold (172) are moved close to each other; and a step (T150 to T170) of bringing the tubular member plastically deformed by the compressing into an elastically deformable second state and extending the bellows structure portion (63) to remove the outer ring mold (171) and the inner ring mold (172). In this way, it is possible to easily provide the bellows (60) including the bellows structure portion (63) which is rich in elasticity and has excellent durability.

### BRIEF DESCRIPTION OF THE DRAWINGS

FIG. 1 is a schematic configuration view showing a fuel tank system including the variable volume device of an embodiment;

FIG. 2 is a side view showing the appearance of the variable volume device with a case cut away;

FIG. 3 is a perspective view showing the appearance of the bellows of the embodiment;

FIG. 4 is an illustrative view showing a shape of the bellows used in the variable volume device;

FIG. 5 is an illustrative view showing the deformation of the bellows used in the embodiment;

FIG. 6 is an illustrative view showing the deformation of a bellows in a reference example;

FIG. 7 is a perspective view showing another shape of the bellows;

FIG. 8 is a process chart showing a method for manufacturing the bellows;

FIG. 9 is an illustrative view showing the arrangement of jig components in the manufacturing process of the bellows;

FIG. 10 is an illustrative view showing the arrangement of the jig in the manufacturing process of the bellows;

FIG. 11 is an illustrative view showing a step of compressing a member in the manufacturing process of the bellows;

FIG. 12 is an illustrative view showing how the jig components are removed;

FIG. 13 is an illustrative view showing another example of the form of the bellows; and

FIG. 14 is an illustrative view showing another form of the fuel tank system including the variable volume device.

### DESCRIPTION OF THE PREFERRED EMBODIMENTS

### A. First Embodiment

### (A1) Configuration of Fuel Tank System:

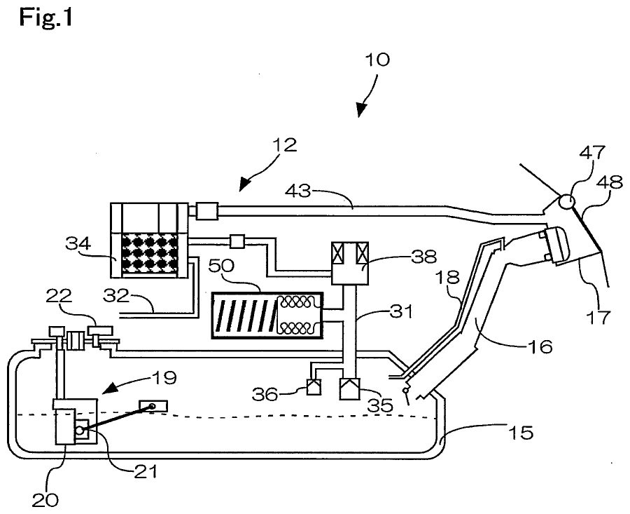

FIG. 1 is a schematic configuration view of a fuel tank system 10 which includes a variable volume device 50 used in a first embodiment. The fuel tank system 10 is a sealed tank system and is installed in a vehicle such as an automobile incorporating an internal-combustion engine. As described later, the fuel tank system 10 includes, in addition to the variable volume device 50, a fuel tank 15, a fuel supply pipe 16 which supplies a fuel to the fuel tank 15, an evaporated fuel processing device 12 which processes the fuel evaporated from the fuel tank 15 and the like.

As shown in the figure, in the fuel tank 15, the fuel supply pipe 16 is provided. The fuel supply pipe 16 is a pipe which introduces the fuel into the fuel tank 15 from a fuel filler opening at its upper end portion, and a tank cap 17 is detachably attached to the fuel filler opening. The interior of the upper end portion of the fuel supply pipe 16 and a gas layer portion in the fuel tank 15 communicate with each other through a breather pipe 18. In the fuel filler opening, a lid 48 capable of being opened and closed to the side of the vehicle is provided, and a lid opener 47 which receives an instruction from the outside to open or close the lid 48 is also provided.

A fuel supply pump device 19 is provided in the fuel tank 15. The fuel supply pump device 19 includes: a fuel pump 20 which sucks the fuel in the fuel tank 15 and pressurizes and discharges the fuel; a sender gauge 21 which senses the liquid surface level of the fuel; a tank internal pressure sensor 22 which detects the inner pressure of the tank as a pressure relative to atmospheric pressure; and the like. The fuel pumped from the fuel tank 15 by the fuel pump 20 is supplied though an unillustrated fuel path to a fuel injection valve provided in an engine.

The evaporated fuel processing device 12 includes a vapor path 31, a purge path 32, a canister 34 and an electromagnetic valve 38. The electromagnetic valve 38 is provided partway through the vapor path 31. One end portion (upstream side end portion) of the vapor path 31 communicates with the gas layer portion in the fuel tank 15. The other end portion (downstream side end portion) of the vapor path 31 communicates with the interior of the canister 34. Activated charcoal (not shown) serving as an adsorbent is filled in the canister 34. The evaporated fuel in the fuel tank 15 is adsorbed to the adsorbent (activated charcoal) in the canister 34 through the vapor path 31. An atmospheric path 43 communicates with the canister 34. The other end portion of the atmospheric path 43 is opened to the atmosphere. The atmospheric path 43 may be omitted.

In the gas layer portion within the fuel tank 15, at the upstream side end portion of the vapor path 31, a full tank detection valve 35 and a fuel cut-off valve 36 are provided. The full tank detection valve 35 is a full tank regulation valve configured with a float valve which is opened and closed by the buoyancy of the fuel, and when the liquid surface of the fuel in the fuel tank 15 is equal to or lower than the liquid surface of the full tank, the float valve is in an opened state whereas when the liquid surface of the fuel is raised to the liquid surface of the full tank by refueling, the float valve is closed to interrupt the vapor path 31. When the vapor path 31 is interrupted, the fuel is filled up to the fuel supply pipe 16, the auto-stop mechanism of a refueling gun is operated and thus the refueling is stopped. The fuel cut-off valve 36 is configured with a float valve which is opened and closed by the buoyancy of the fuel, and is normally held in an opened state, and when the vehicle is rolled over, the fuel cut-off valve 36 is opened to interrupt the flow of the fuel in the fuel tank 15 into the vapor path 31.

The electromagnetic valve 38 provided partway through the vapor path 31 is electrically controlled to open or close the path so as to adjust the flow rate of an evaporated fuel-containing gas (referred to as a “fluid”) flowing through the vapor path 31. In the electromagnetic valve 38, a relief valve may be provided in order to keep appropriate the pressure in the fuel tank 15 when the electromagnetic valve 38 is closed.

The purge path 32 is a path which purges the fuel adsorbed to the canister 34 to the side of the engine when the engine is operated in order to utilize it as the fuel. In the purge path 32, an electromagnetic valve and the like for controlling timing at which the fuel is purged and an unillustrated ECU and the like for controlling the electromagnetic valve and the like are provided. Electrical components such as the electromagnetic valve 38, the lid opener 47 and the fuel pump 20 are also coupled to the ECU as described above, and each of the electrical components receives an instruction from the ECU to operate at desired timing. The detailed description and illustration of the coupling and operations thereof are omitted.

### (A2) Configuration of Variable Volume Device:

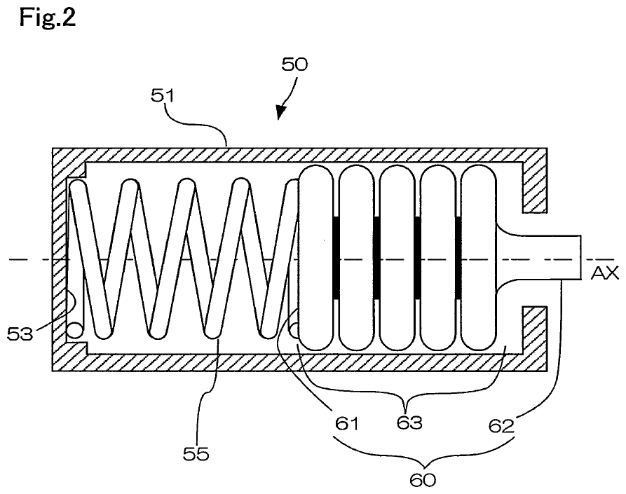

The structure of the variable volume device 50 which is coupled partway through the vapor path 31 extending from the fuel tank 15 to the electromagnetic valve 38 will be described. FIG. 2 is an illustrative view showing the interior of the variable volume device 50 with a case 51 cut away. As shown in the figure, the variable volume device 50 includes the case 51, a bellows 60 which is stored therewithin and serves as a variable volume portion and a compression spring 55 which biases the bellows 60 in the direction of compression. The bellows 60 is formed of a synthetic resin. A method for manufacturing the bellows 60 will be described later. The compression spring 55 is interposed between a blocking wall 61 provided at one end of the bellows 60 and the bottom wall 53 of the case 51. The bellows 60 includes: a coupling port 62 through which a fluid, that is, the evaporated fuel here exits and enters; and a bellows structure portion 63 which is provided on the outer circumference of a tubular member. The coupling port 62 is coupled to the vapor path 31 to make the vapor path 31 and the interior of the bellows structure portion 63 communicate with each other. The bellows structure portion 63 is extended and compressed in the direction of the central axis AX of the tubular member by the pressure of the evaporated fuel received through the coupling port 62, and thus the internal volume thereof is changed. The compression spring 55 helps the bellows structure portion 63 compress to its original length when the pressure of the evaporated fuel is lowered. The length of the bellows structure portion 63 in the direction of the central axis AX is minimized when the internal pressure is equal to the atmospheric pressure. Once the bellows structure portion 63 is extended by receiving the internal pressure, since the bellows structure portion 63 is formed of the synthetic resin, it is likely that even when the internal pressure is removed, the bellows structure portion 63 may not completely returned to the original length. Even in such a state, the bellows structure portion 63 is returned to the original length by the elastic force of the compression spring 55.

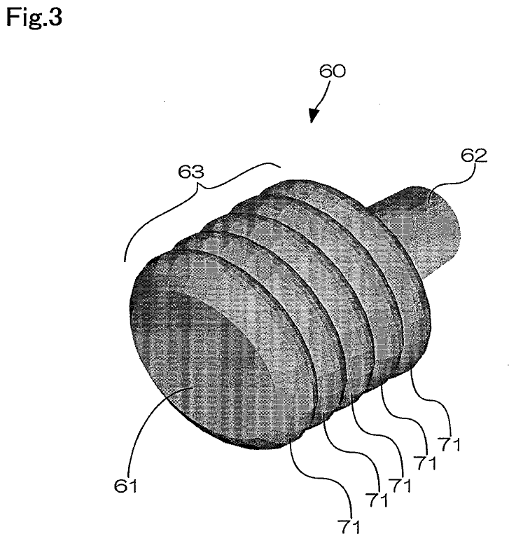

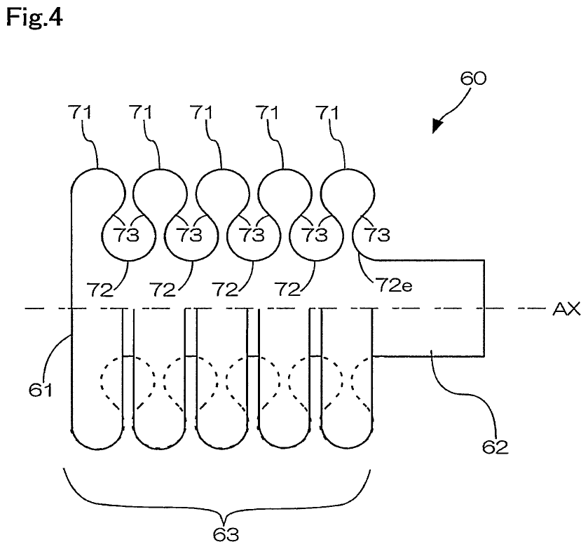

FIG. 3 is a perspective view showing the appearance of the bellows structure portion 63. FIG. 4 is an illustrative view showing the bellows structure portion 63 by viewing one side on the central axis AX in cross section and viewing the other side of the external shape in side view. In this embodiment, the bellows structure portion 63 includes five folds of the bellows. As shown in FIG. 4, the bellows structure portion 63 includes: five first portions 71 which protrude outward in the radial direction of the tubular member, are formed in an arc shape and are aligned along the central axis AX in a cross section along the central axis AX of the tubular member; four second portions 72 which are recessed inward in the radial direction relative to the first portions 71, are formed in an arc shape and are aligned between the five first portions 71; coupling portions 73 which make the first portions 71 couple to the adjacent second portions 72 without any singularity. Here, the “without any singularity” refers to the fact that there is no tangent or two or more tangents are not present at the coupling point of the first portion 71 and the coupling portion 73 and at the coupling point of the coupling portion 73 and the second portion 72. In other words, the “without any singularity” refers to the fact that in a coupling part between one portion and the other portion, a tangential direction smoothly changes. The first portion 71 which is closest to the side of the coupling port 62 and the coupling port 62 are likewise coupled without any singularity. Hence, this portion is considered to be a semi-second portion 72e where half of the second portion is present, and may be regarded as being coupled to the first portion 71 through the coupling portion 73.

Here, the central angle of each of the arc shapes of the first portion 71 and the second portion 72 is greater than 180 degrees. In the present embodiment, the central angles θ each are 270 degrees. The central angles of the first portion 71 and the second portion 72 each are preferably greater than 180 degrees or may be equal to or different from each other as long as the first portion 71 and the second portion 72 are coupled by the coupling portion 73 without any singularity. The length of the coupling portion 73 is shorter than the length of the arc of the first portion 71. The length of the coupling portion 73 is more preferably shorter than half of the length of the arc of the first portion 71. The length of the coupling portion 73 may be zero. The coupling portion 73 may have a linear shape or a curved shape or may include both the shapes. Preferably, with consideration given to the deformation of the bellows structure portion 63 caused by the internal pressure, the shapes of the five first portions 71, the shapes of the four second portions 72 and the shapes of the nine coupling portions 73 are individually the same as each other. If the thicknesses and the materials of the first portions 71 and the second portions 72 are originally adjusted such that the first portions 71 and the second portions 72 are individually deformed in the same manner, the first portions 71 and the second portions 72 do not necessarily need to have the same shapes.

### (A3) Deformation of Bellows Structure Portion:

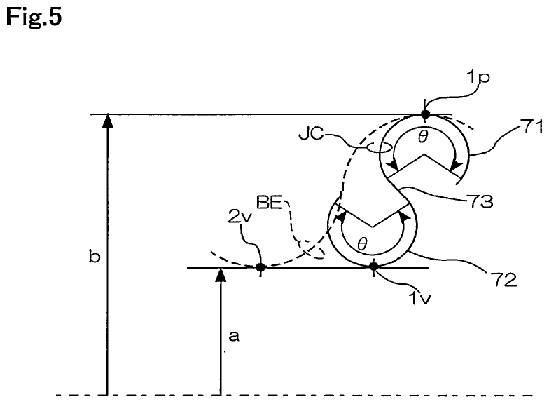

The deformation of the bellows structure portion 63 having the configuration described above will be described. The bellows 60 provided in the variable volume device 50 receives the pressure of the evaporated fuel (hereinafter referred to as the “internal pressure”) through the vapor path 31 to change its length in the direction of the central axis AX, and thereby changes the internal volume. When the length in the direction of the central axis AX is increased, the internal volume is increased whereas when the length in the direction of the central axis AX is decreased, the internal volume is decreased. The deformation of the bellows structure portion 63 caused by the internal pressure will be schematically described with reference to FIG. 5. Although the exact description of the deformation of the bellows structure portion 63 is given based on structural analysis, the exact description is omitted here.

In FIG. 5, the shapes of the first portion 71, the second portion 72 and the coupling portion 73 when the internal pressure is equal to the atmospheric pressure are indicated by a solid line JC, and the shapes of the first portion 71, the second portion 72 and the coupling portion 73 when the internal pressure is greater than the atmospheric pressure to deform the bellows structure portion 63 are indicated by a broken line BE. The outer diameter of the first portion 71 before the deformation, that is, a distance from the central axis AX is indicated by a symbol b, and the inner diameter of the second portion 72, that is, a distance from the central axis AX is indicated by a symbol a respectively. Here, the outermost point of the first portion 71 is indicated by a symbol 1p, and the innermost point of the second portion 72 is indicated by a symbol 1v.

When in this state, the internal pressure exceeds the atmospheric pressure, the bellows structure portion 63 is increased in length along the central axis AX, on the assumption that the outermost point 1p of the first portion 71 is a reference point, as indicated by the broken line BE, the innermost point 1v of the second portion 72 is moved to a point 2v. Here, in the bellows structure portion 63 of the present embodiment, the distance a from the central axis AX to the innermost point 2v of the second portion 72 is substantially equal to the distance a to the innermost point 1v before being moved. This is because the central angle θ of each of the first portion 71 and the second portion 72 is greater than 180 degrees. A distance (line length) from the outermost point 1p of the first portion 71 to the innermost point 1v of the second portion 72 along the bellows structure portion 63 is sufficiently longer than a linear distance from the outermost point 1p to the innermost point 1v. In actuality, as the bellows structure portion 63 is moved along the central axis AX by the internal pressure, the curvature radii of the arc portions of the first portion 71 and the second portion 72 are increased. Consequently, even when the bellows structure portion 63 is extended in the direction of the central axis AX by the internal pressure, a force is almost never exerted which changes the distances from the central axis AX to the outermost point 1p of the first portion 71 and to the innermost point 2v of the second portion 72 in the radial direction. In other words, even when the bellows structure portion 63 is extended by the internal pressure, a large force in the radial direction is not exerted on the first portion 71 and second portion 72. In the bellows structure portion 63, as shown in FIG. 3, the first portion 71 and the second portion 72 are originally formed in an annular shape. In other words, in order to cause deformation for decreasing the outer diameter of the first portion 71 and deformation for increasing the inner diameter of the second portion 72, a large load is exerted on each of the portions. In the present embodiment, the distances from the central axis AX to the outermost point 1p of the first portion 71 and to the innermost point 2v of the second portion 72 in the radial direction are almost never changed, and thus large stress is prevented from being applied to the portions of the bellows structure portion 63. As the bellows structure portion 63 is further extended in the direction of the central axis AX in a state indicated by the broken line BE in FIG. 5, the outer shape of the bellows structure portion 63 in cross section approaches a straight line connecting the outermost point 1p and the innermost point 1v. However, until a complete straight line is achieved, the bellows structure portion 63 is able to be further extended in the direction of the central axis AX without the outermost point 1p being moved inward in the radial direction and without the innermost point 1v being moved outward in the radial direction.

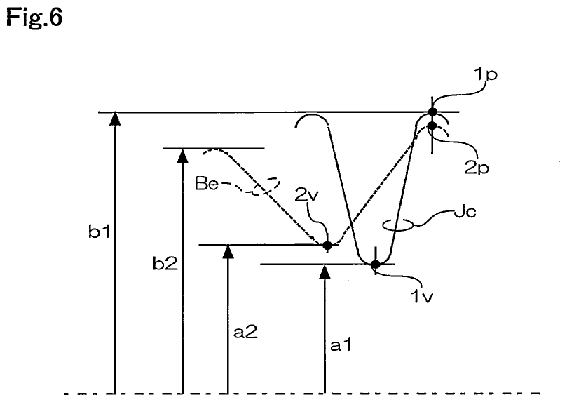

FIG. 6 is an illustrative view showing the deformation of portions of a conventional bellows as a reference example. In the bellows of the reference example, the central angles of arch shapes corresponding to the first portion and the second portion of the bellows structure portion 63 of the embodiment are less than 180 degrees, and moreover, the radii of the arcs are small, with the result that both the portions are coupled by a long straight portion. In the figure, a solid line Jc schematically indicates an initial state where the internal pressure is not applied and the bellows is compressed, and a broken line Be schematically indicates a state where the internal pressure is applied and the bellows is extended in the direction of the central axis AX.

As shown in the figure, in the initial state where the internal pressure is not applied, the outermost point 1p of the bellows in the radial direction is separated by a distance b1 from the central axis AX, and the innermost point 1v in the radial direction is separated by a distance a1 from the central axis AX. When the internal pressure is increased in this state, the bellows is extended in the direction of the central axis AX, and however, the outermost point 2p needs to be moved to a position a distance b2 from the central axis AX and the innermost point 2v needs to be moved to a position at a distance a2 from the central axis AX so that the bellows is extended. Consequently, b1>b2 and a1<a2. In other words, in the conventional bellows, deformation in which the outer diameter of the bellows, is decreased and the inner diameter is increased is inevitably caused so that the bellows is extended along the central axis AX.

This is due to the following reasons. Since in the bellows shown as the reference example, the central angles of the arch-shaped portions corresponding to the first portion and the second portion are less than 180 degrees, and the radii of the arcs are small, even when the curvature radii of the portions are increased, the distance from the outermost point 1p to the innermost point 2v is little affected. The straight portion connecting both the portions is inclined as the bellows is extended, and thus a distance perpendicular to the central axis AX in the radial direction is shortened. Hence, a load for deforming the bellows inward in the radial direction is applied to the outermost point, and a load for deforming the bellows outward in the radial direction is applied to the innermost point.

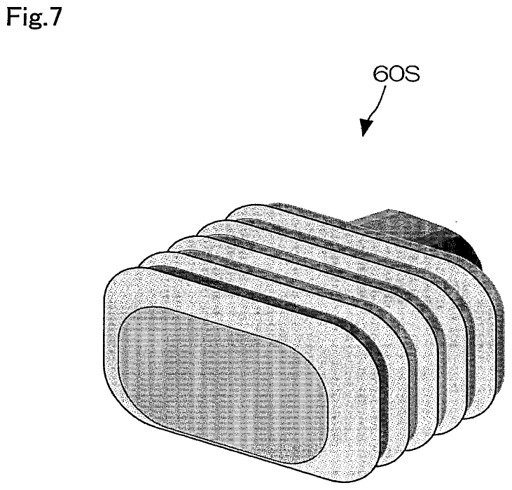

As described above using the reference example, when in the bellows, the amount of movement along the direction of the central axis AX is increased in order to greatly increase or decrease the internal volume, a load for causing deformation in the radial direction is applied to the bellows, in particular, to around the outermost point and to around the innermost point in the radial direction. In the conventional bellows, a load is applied to decrease the diameter of the outer circumference in the radial direction and to increase the diameter of the inner circumference in the radial direction, and moreover, the curvature radii of the outermost circumference and the innermost circumference are small, with the result that stress is repeatedly applied to the portions to make it difficult to acquire sufficient durability. By contrast, in the present embodiment, the problem as described above is unlikely to occur, and thus it is possible to increase and decrease the internal volume, with the result that it is possible to realize high durability. Although in the above description, as the bellows 60, the bellows in the cylindrical shape shown in FIG. 3 is used, a bellows 60S or the like in a rectangular tubular shape with rounded corners as shown in FIG. 7 may be used.

### (A4) Function as Fuel Tank System:

In the variable volume device 50 using the bellows 60 of the embodiment described above, the internal volume is able to be significantly increased by the internal pressure, and moreover, high durability is realized. Hence, in the fuel tank system 10 using the variable volume device 50, the fuel tank 15 is sealed, and when the evaporation of the fuel proceeds and thus the internal pressure of the fuel tank 15 is increased, the internal volume of the variable volume device 50 is increased, with the result that the increase in the internal pressure is suppressed. Hence, a description will be given of the operation of the fuel tank system 10 using the sealed fuel tank 15 and the variable volume device 50 of the present embodiment.

The electromagnetic valve 38 is maintained in a closed state except the time of refueling when the fuel is supplied to the vehicle. Hence, the evaporated fuel in the fuel tank 15 is prevented from flowing into and being adsorbed to the canister 34. When in a state where the electromagnetic valve 38 is closed such as a case where the vehicle is parked, the fuel in the fuel tank 15 is evaporated, as described above, the internal volume of the variable volume device 50 is changed, with the result that the internal pressure of the fuel tank 15 is kept in an appropriate range.

Although the electromagnetic valve 38 is also maintained in a closed state while the vehicle is traveling, when predetermined purge conditions are established, for example, an unillustrated electromagnetic valve is opened to make the canister 34 communicate with an unillustrated intake path of the engine through the purge path 32. Consequently, the intake negative pressure of the engine acts on the interior of the canister 34 through the purge path 32, the evaporated fuel adsorbed to the canister 34 is purged to the intake path and is burned in the engine. With respect to the purging of the evaporated fuel, the electromagnetic valve 38 may be opened to purge the evaporated fuel in the fuel tank 15, and thus the internal pressure of the fuel tank 15 may be lowered to about the atmospheric pressure.

When an unillustrated lid switch for opening the lid 48 is operated for refueling, the electromagnetic valve 38 is opened. Here, when the internal pressure of the fuel tank 15 is greater than the atmospheric pressure, the bellows 60 of the variable volume device 50 is expanded. However, at the same time when the electromagnetic valve 38 is opened, the evaporated fuel in the fuel tank 15 and the variable volume device 50 is passed through the vapor path 31 and is adsorbed to the adsorbent in the canister 34. In this way, the internal pressure of the fuel tank 15 is lowered, and thus the lid 48 is opened, and even when the fuel is supplied, the discharge of the evaporated fuel to the atmosphere is prevented or suppressed. A configuration may be adopted in which even when the lid switch for providing an instruction to open or close the lid is operated, the lid 48 is not immediately opened, the adsorption of the evaporated fuel to the canister 34 proceeds, the internal pressure of the fuel tank 15 is lowered to a value near the atmospheric pressure and thereafter the lid 48 is opened. In this way, even when the lid 48 is opened and the tank cap 17 is opened, the discharge of the evaporated fuel to the atmosphere is prevented. This is also true during refueling. Until refueling is completed and the lid 48 is closed, the electromagnetic valve 38 may be maintained in an opened state. In this way, even when the evaporated fuel is generated at the time of refueling, the evaporated fuel is passed through the vapor path 31 and is adsorbed to the adsorbent in the canister 34.

The fuel tank system 10 described above is sealed, uses the variable volume device 50 to increase the volume of the gas phase portion of the fuel tank 15 and is thereby able to prevent the increase in the pressure of the fuel tank 15. Hence, it is not necessary to excessively increase the pressure resistance of the fuel tank 15. Consequently, the thickness of the plate of the fuel tank 15 does not need to be excessively increased, and thus the weight of the fuel tank 15 is prevented from being increased. As a result, this can also contribute to improving the fuel efficiency of the vehicle and the like. Furthermore, it is possible to suppress the necessity for fitting a heat insulator or the like to the fuel tank 15 to reduce an increase in the temperature of the fuel tank 15. It is also unnecessary to provide a complicated mechanism for changing the volume of the fuel tank 15 itself.

Furthermore, in a hybrid car, a plug-in hybrid car or the like where timing at which the fuel adsorbed to the canister 34 is burned in the engine is limited, the volume of the canister 34 does not need to be excessively increased, and an event in which the evaporated fuel incapable of being adsorbed is inevitably discharged to the atmosphere is easily avoided. Moreover, since the bellows 60 of the variable volume device 50 used therefor has high durability, the bellows 60 is able to be used for a long period of time.

### B. Method for Manufacturing Bellows 60

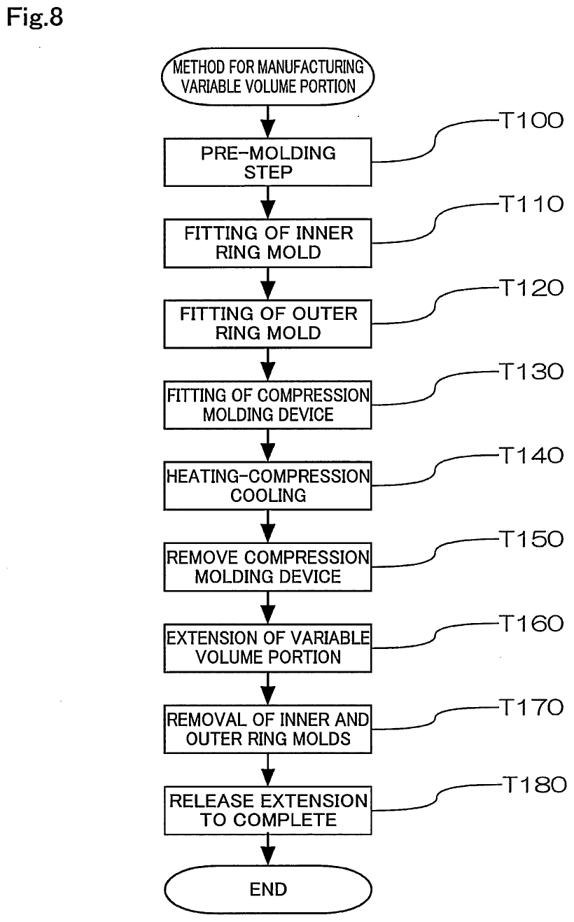

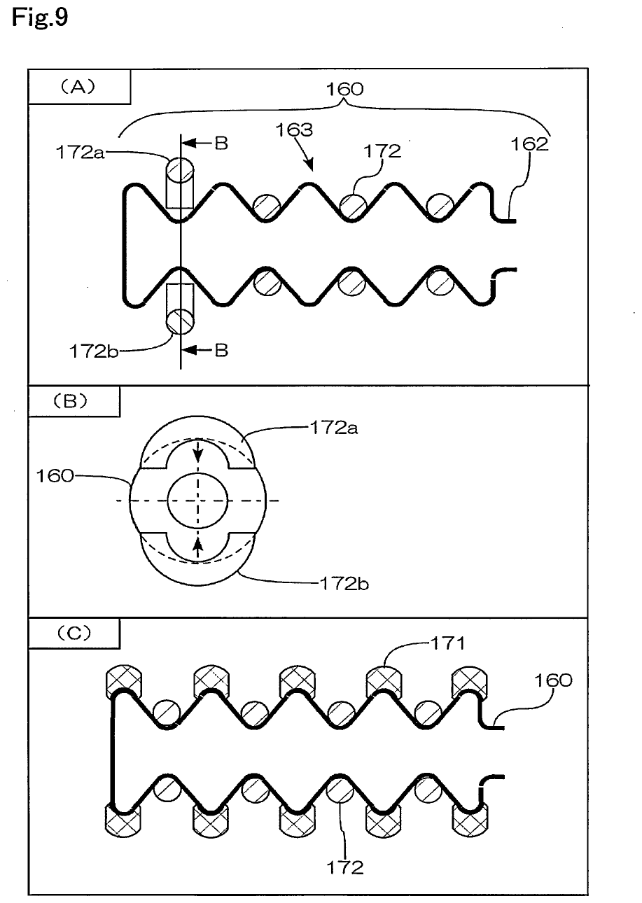

A method for manufacturing the bellows 60 serving as the variable volume device described above will be described. FIG. 8 is a process chart showing the method for manufacturing the bellows. When the bellows 60 is manufactured, a pre-molded product to be molded into the bellows 60 is first molded (step T100). An example of the pre-molded product 160 is shown in the column (A) of FIG. 9. The pre-molded product 160 as described above is able to be manufactured by blow molding or injection blow molding of a synthetic resin. As the material of the pre-molded product 160, various materials may be used as long as the material has moldable plasticity and flexibility and elasticity after being molded. When the material which has low elasticity after being molded and a high degree of flexibility is used, a spring or the like for returning it to a compressed state is preferably provided. Although the bellows 60 also needs to have permeability resistance to the evaporated fuel, if post-processing for forming a low-permeability covering or coating on the surface of the pre-molded product 160 is performed to obtain permeability resistance, the permeability resistance of the resin itself is not required. When two or more layers are originally provided, part of the layers may be formed of a low-permeability material.

When one layer is formed, examples of the material having permeability resistance include polyamides such as PA11 and PA66 whereas when two layers are formed, examples of the material having permeability resistance include PA12/PA9T, ETFE/PA12, ETFE/PA1012 and the like. Even a resin, such as a PE single layer, which has low fuel permeability resistance in itself may be utilized as long as post-processing or the like is performed to enhance the permeability resistance. Multiple layering including EVOH, PA and ETFE may be originally formed to provide permeability resistance.

The pre-molded product 160 includes a tubular portion 163 which is finally molded into the bellows structure portion 63 and a small diameter portion 162 which is molded into the coupling port 62. The tubular portion 163 is pre-molded into a shape where a convex portion and a concave portion are repeated according to the shapes of the first portions 71 and the second portions 72 of the bellows 60.

An operation of fitting an inner ring mold to the pre-molded product 160 subjected to the pre-molding is then performed (step T110). The inner ring mold 172 is a mold which has a circular cross section and is ring-shaped, and is arranged in a plurality of parts (in this example, four parts) of the pre-molded product 160 that are most recessed in order to mold the second portions 72 in the pre-molded product 160. The inner ring mold 172 is divided into a first ring mold 172a and a second ring mold 172b which have approximately the same shape, and the first ring mold 172a and the second ring mold 172b are fitted to each other to form the inner ring mold 172 surrounding the entire innermost circumference of the pre-molded product 160. This state is shown in the column (A) and the column (B) of FIG. 9 showing a cross section taken along line B-B.

Following the arrangement of the inner ring mold 172, an operation of fitting an outer ring mold 171 is performed (step T120). The outer ring mold 171 is arranged on parts of the pre-molded product 160 which project most outward. The outer ring mold 171 has a cross-sectional shape where its inner side is recessed in an arc shape, and two members are fitted to each other from the outside as in the inner ring mold 172 to surround the entire outermost circumference of the pre-molded product 160. The outer ring mold 171 is arranged on a plurality of parts (in this example, five parts) according to the shape of the pre-molded product 160. This state is shown in the column (C) of FIG. 9. Regardless of which one of steps T110 and T120 is first performed, steps T110 and T120 may be performed simultaneously or step T120 may be performed before step T110.

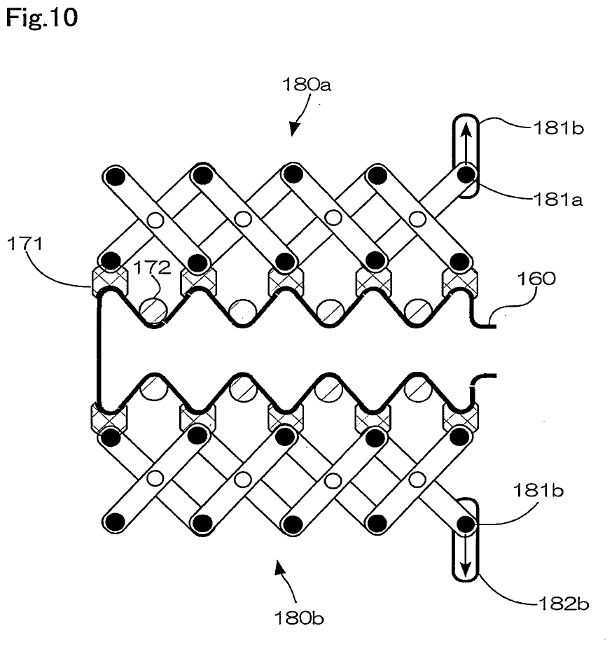

In this way, the inner ring mold 172 is arranged in the innermost circumferential portion of the pre-molded product 160, and the outer ring mold 171 is arranged on the outermost circumferential portion, and thereafter a compression molding device is fitted (step T130). An example of the compression molding device 180 is shown in FIG. 10. The compression molding device 180 has a so-called multi-segment link (magic hand) configuration, and a total of six compression molding devices are spaced at 60-degree intervals in a circumferential direction so as to surround the outer circumference of the pre-molded product 160. In the figure, among them, compression molding devices 180a and 180b are shown which are spaced at 180-degree intervals. The six compression molding devices 180 are operated synchronously. As long as the pre-molded product 160 is originally compressed, any number of compression molding devices 180 may be provided.

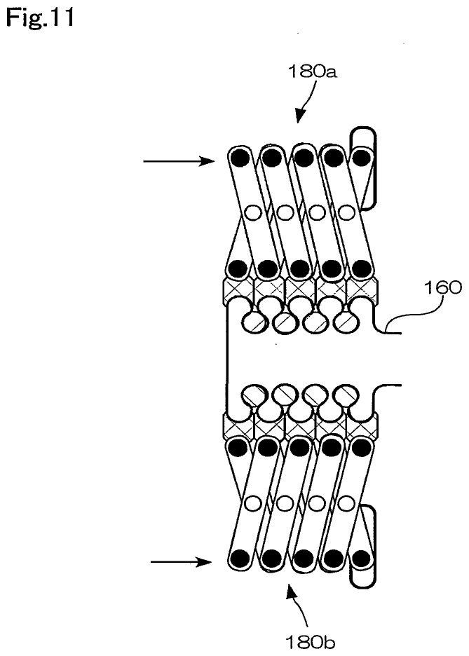

In the compression molding device 180, among parts where links are externally combined, the outer ring mold 171 is arranged on parts placed inward relative to the pre-molded product 160. At a link tip of link final ends on the side (outer side) where the outer ring mold 171 is not arranged, a drive pin 181a is provided, and the drive pin 181a is slidably placed in a groove 181b. When in this state, the drive pin 181a is made to slide in the groove 181b, as shown in FIG. 11, the compression molding device 180 is compressed, and the pre-molded product 160 is also compressed accordingly. Here, the multi-segment link is driven so as to keep constant the positions where the multi-segment link is coupled to the outer ring mold 171 and a distance of the pre-molded product 160 in the radial direction.

Then, the compression molding device 180 is fitted to the pre-molded product 160 (step T130), the pre-molded product 160 is heated and the pre-molded product 160 is compressed using the compression molding device 180 and is thereafter cooled (step T140). The pre-molded product 160 is compressed into a shape shown in FIG. 11 and is cooled in this state. Consequently, the pre-molded product 160 using a thermoplastic synthetic resin is formed into the shape of the bellows 60 shown in FIG. 4.

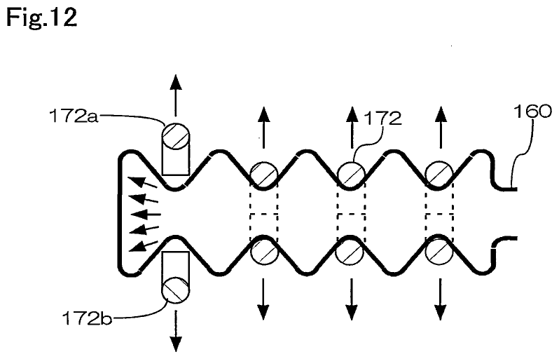

After the molded bellows 60 is sufficiently cooled, the compression molding device 180 is then removed (step T150). Thereafter, air having a predetermined pressure is fed into the bellows 60 from the coupling port 62 to extend the bellows structure portion 63 of the bellows 60 (step T160). This state is illustrated in FIG. 12. Since the bellows 60 is flexible even in a cooled state and is elastically deformable, when the internal pressure P exceeds the atmospheric pressure, the bellows 60 is extended in the direction of the central axis AX. In this state, the inner ring mold 172 is separated into the first ring mold 172a and the second ring mold 172b to be removed from the bellows 60 (step T170). Thereafter, the internal pressure is removed to release the extension of the bellows 60, and thus the bellows 60 is returned to its original length, that is, a compressed state, with the result that the bellows 60 is completed (step T180). By the steps described above, the bellows 60 of the embodiment is manufactured.

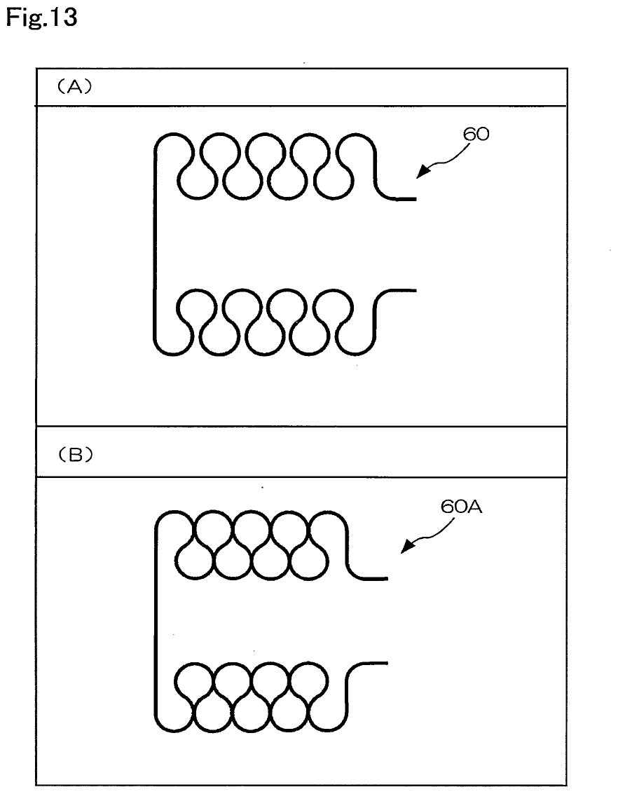

An example of the bellows 60 manufactured by the steps described above is shown in the column (A) of FIG. 13. Although in this example, the adjacent first portions 71 and the adjacent second portions 72 are not in contact with each other, in step T140 for heating and compressing, the pre-molded product 160 may be compressed to positions in which the portions are in contact with each other so as to form the bellows 60 like a bellows 60A shown in the column (B) of the figure. When the pre-molded product 160 is compressed such that the portions are in contact with each other, it is possible to reduce the total length of the bellows 60 and to increase the rate of increase in the internal volume when the bellows 60 is extended.

### C. Second Embodiment

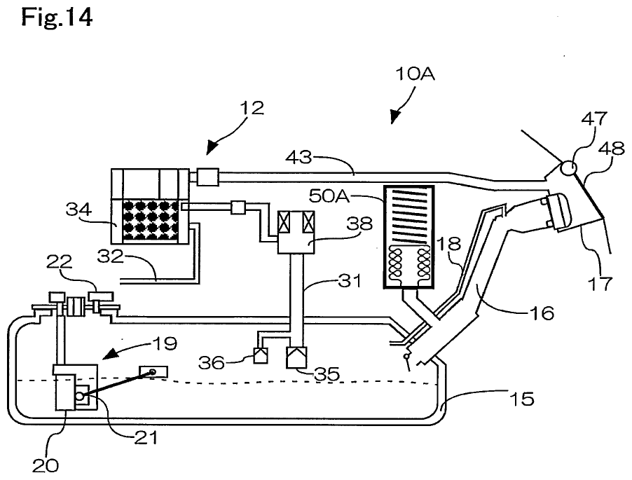

Another embodiment serving as a fuel tank system 10A is shown in FIG. 14. In the fuel tank system 10A, a variable volume device 50A does not communicate with the vapor path 31, and the coupling port 62 is coupled to the fuel supply pipe 16. Although in the first embodiment, the central axis AX in the variable volume device 50A is in a horizontal direction, the central axis AX is in a vertical direction in the present embodiment.

In this way, as in the first embodiment, when the pressure in the fuel tank 15 is increased, the internal volume of the variable volume device 50A is increased, and thus the increase in the internal pressure of the fuel tank 15 is suppressed. Since the variable volume device 50A is arranged in the vertical direction, and thus the coupling port 62 is directed in a vertically downward direction, the fuel to be supplied to the fuel supply pipe 16 is unlikely to enter the variable volume device 50A, and even if the fuel enters the variable volume device 50A, the fuel is returned to the side of the fuel supply pipe 16 by its weight and is discharged. When the variable volume device 50A is arranged along the vertical direction as described above, the direction of compression of the variable volume device 50A coincides with the direction of gravity. Hence, instead of the compression spring 55, a weight having a predetermined weight may be arranged on the blocking wall 61 of the bellows structure portion 63 to assist the compression of the bellows structure portion 63 when the internal pressure of the fuel tank 15 is lowered. The variable volume device 50A may be provided near the fuel supply pipe 16, and for example, in the case of a vehicle, the variable volume device 50A may also be installed in a wheelhouse.

### D. Other Embodiments

(1) The variable volume device of the present disclosure may be practiced in other embodiments. A variable volume device according to another embodiment includes: a coupling port which is coupled to an internal space of a fuel tank; and a variable volume portion in which the length of a bellows structure portion provided on an outer circumference of a tubular member in an axial direction is extended and compressed by an internal pressure of the fuel tank such that the volume of the tubular member is changed. Here, the bellows structure portion may include: a first portion which protrudes outward in the radial direction of the tubular member and is formed in an arc shape in a cross section along a central axis of the tubular member; a second portion which is recessed inward in the radial direction relative to the first portion and is formed in an arc shape; and a coupling portion which makes the first portion couple to the second portion without any singularity, and the central angle of each of the arc shapes of the first portion and the second portion may be greater than 180 degrees. In this way, when the internal pressure of the fuel tank coupled to the variable volume portion exceeds the atmospheric pressure, the length of the bellows structure portion in the radial direction is increased, the internal volume thereof is increased and the increase in the internal pressure of the fuel tank is suppressed. Here, since in the first portion and the second portion of the bellows structure portion, the central angle thereof is greater than 180 degrees and the bellows structure portion includes the coupling portion which makes the first portion couple to the second portion without any singularity, the length of the bellows structure portion in the axial direction is increased over a predetermined range without the outermost diameter of the first portion and the innermost diameter of the second portion being significantly changed. Hence, the variable volume portion is able to realize high durability without large stress being applied to the portions of the bellows structure portion.

Here, the coupling portion preferably couples the first portion and the second portion without any singularity, and the length thereof may be zero. For example, when the first portion and the second portion are symmetric with respect to an axis line in the radial direction, the central angle of the first portion is α° and the central angle of the second portion is β° and α and β satisfy formula (1) below, since a tangential direction at an end point of the first portion coincides with a tangential direction at an end point of the second portion, both the end points are preferably directly coupled or coupled with the linear coupling portion having a predetermined length.

α=β and 180<α, β≤270 (1)

When both the end points of the first portion and the second portion are directly coupled, the coupling portion is a point and does not have a substantial length. When the coupling portion is originally curved, conditions under which the coupling portion is coupled to the second portion without any singularity are relaxed. For example, α and β may be equal to or greater than 270. In this case, α≠β may be established or the first portion and the second portion do not need to be symmetric with respect to the axis line in the radial direction.

Since the variable volume device is coupled to the internal space of the fuel tank by the coupling port, when the internal pressure of the fuel tank is increased, the internal volume of the variable volume portion of the variable volume device is increased, and thus the increase in the internal pressure of the fuel tank is suppressed. Hence, it is possible to easily configure a sealed tank system.

(2) In the configuration described above, the coupling port may be provided at one end of the tubular member in the axial direction and a blocking wall may be provided at the other end. In this way, the pressure of the fuel tank with the tubular member coupled to the coupling port is directly received by the blocking wall, and thus the movement of the bellows structure portion provided in the tubular member in the axial direction is smooth. An elastic member such as a spring is fitted to the blocking wall, and thus it is easy to support the movement of the bellows structure portion in the direction of compression. The coupling port and the blocking wall may be originally arranged at parts other than both ends in the axial direction. For example, the coupling port may be provided to be directed in a direction intersecting the axial direction of the bellows structure portion.

(3) In the configuration described above, a biasing member which biases the tubular member to the side of an initial position may be fitted to the blocking wall. In this way, the material of the bellows structure portion does not need to be a material which exhibits elasticity for returning to the initial position after deformation caused by the internal pressure. Hence, the flexibility of selection of the material of the bellows structure portion is increased. The material and the structure of the bellows structure portion which exert a force for returning to the side of the initial portion may be originally adopted. As the biasing member, a spring, an elastomer or the like may be used. A compression spring which biases the blocking wall from the outside may be adopted or a tension spring which is provided inside the bellows structure portion to bias the blocking wall to inward may be adopted. The spring may be a coil spring or a plate spring. When the bellows structure portion is arranged in the vertical direction with the blocking wall on the upper side, the biasing member may be a heavyweight material which biases the blocking wall downward by gravity, that is, to the side of the initial position. A configuration may be adopted in which the blocking wall is biased by magnetic force, compressed air or the like.

(4) In the configuration described above, the tubular member may be formed in a cylindrical shape. In this way, there is no part where stress is easily concentrated in the circumferential direction of the tubular member, and thus it is possible to enhance the durability of the bellows structure portion. The tubular member may be a rectangular tubular shape or the like, and has preferably a shape in which the installation space of the variable volume device is able to be effectively utilized.

(5) In the configuration described above, two or more first portions and two or more second portions may be provided. In this way, it is possible to increase the internal volume of the variable volume portion. The number of first portions may be equal to the number of second portions, or the first portions may be provided one more than the second portions.

(6) In a sealed tank system including: a fuel tank; a canister which is coupled to the fuel tank by a pipe path to adsorb an evaporated fuel; an on-off valve which is provided in the pipe path; and any one of the variable volume devices described above, the coupling port of the variable volume device may be configured to be coupled to the pipe path. In this way, it is possible to easily configure the sealed tank system, and the volume of the variable volume portion of the variable volume device is changed to be able to easily suppress the increase in the pressure in the fuel tank. In this case, the on-off valve may be an electric valve such as an electromagnetic valve, and may be opened and closed according to the operation conditions of a vehicle or the like to control timing at which the evaporated fuel in the fuel tank is guided to the canister. In order to control the timing as described above, a control unit such as an ECU may be provided.

(7) Alternatively, in a sealed tank system including: a fuel tank; a fuel supply pipe which couples the fuel tank and a fuel filler opening; and any one of the variable volume devices described above, the coupling port of the variable volume device may be configured to be coupled to the fuel supply pipe. In this way, it is also possible to easily configure the sealed tank system, and the volume of the variable volume portion of the variable volume device is changed to be able to easily suppress the increase in the pressure in the fuel tank.

Even when any one of the configurations described above is adopted, since the durability of the variable volume device is high, it is possible to reduce the maintenance of the sealed tank system. It is not necessary to excessively increase the pressure resistance of the fuel tank in order to achieve a sealed tank system. Furthermore, since it is possible to suppress the adsorption of the evaporated fuel to the canister, even when timing at which the fuel adsorbed to the canister is burned is limited, the adsorbent of the canister does not need to be excessive.

(8) In the configuration described above, the variable volume device may be arranged such that the coupling port is directed in a vertically downward direction. In this way, even when the fuel being supplied enters the variable volume device, the fuel is able to be easily discharged by its weight.

(9) In another embodiment of the present disclosure, a method for manufacturing a bellows used for the above-mentioned variable volume device. The manufacturing method includes: molding the tubular member into a shape in a state where the bellows structure portion is extended; surrounding a predetermined area including a top of a first portion of the bellows structure portion by an outer ring mold including a concave portion whose cross section along the center axis of the tubular member has an arc shape, the first portion protruding outward in a radial direction; surrounding a predetermined area including a valley of a second portion of the bellows structure portion by an inner ring mold including a convex portion whose cross section along the center axis of the tubular member has an arc shape, the second portion being recessed inward in the radial direction relative to the first portion; bringing the tubular member into a plastically deformable first state and compressing the bellows structure portion in a direction in which the outer ring mold and the inner ring mold are moved close to each other; and bringing the tubular member plastically deformed by the compressing into an elastically deformable second state and extending the bellows structure portion to remove the outer ring mold and the inner ring mold. In this way, it is possible to easily provide the bellows including the bellows structure portion which is rich in elasticity and has excellent durability.

Here, as long as the tubular member is made of a material such as a synthetic resin which is able to be brought into the plastically deformable first state and is also able to be brought into the elastically deformable second state, the material is able to be adopted. For example, it is possible to use a synthetic resin or the like which has thermoplasticity or photoplasticity. When one layer is formed, examples of the synthetic resin having thermoplasticity include polyamides such as PA11 and PA66 whereas when two layers are formed, examples of the synthetic resin having thermoplasticity include PA12/PA9T, ETFE/PA12, ETFE/PA1012 and the like. Ad-PE/EVOH/Ad-PE/PE of four layers and the like may be utilized. In addition, a multilayer structure of nylon or fluorine and EVOH (ethylene-vinyl alcohol copolymer) may also be adopted. Since the tubular member is highly likely to make contact with the evaporated fuel from the fuel tank, the tubular member preferably has permeability resistance to the fuel. Even a resin, such as a PE single layer, which has low fuel permeability resistance in itself may be utilized as long as a low-permeability and a multilayer structure are provided or a low-permeability covering or coating is formed by post-processing to enhance the permeability resistance. Instead of the synthetic resin, an elastic material such as rubber may be used.

The outer ring mold and the inner ring mold preferably have shapes corresponding to the outer shape of the tubular member, and when the tubular member has a cylindrical shape, they preferably have shapes in which the inner side is circular. When a cross section of the tubular member perpendicular to the axial direction is rectangular, the ring members preferably have shapes in which the inner side is rectangular.

(10) In the configuration described above, the outer ring mold and the inner ring mold each may be divided into a plurality of parts in a circumferential direction. In this way, firstly, the inner ring mold is able to be easily fit to the extended tubular member, and is able to be easily removed after the compression. The number of divisions is preferably two or more, and the outer ring mold and the inner ring mold may be divided in the same positions or may be divided in different positions.

(11) In the configuration described above, the tubular member may be formed of a thermoplastic synthetic resin, the first state may be a state where the temperature of the synthetic resin is kept equal to or greater than a temperature at which the synthetic resin is plastic and the second state may be a state where the temperature of the synthetic resin is kept less than the temperature at which the synthetic resin is plastic. In this way, it is possible to easily compress the tubular member and to easily elastically deform the bellows structure portion in the manufactured bellows by the internal pressure.

(12) The present disclosure is not limited to the embodiments described above and may be realized by various configurations without departing from the spirit thereof. For example, the technical features of the embodiments corresponding to the technical features in the aspects described in SUMMARY may be replaced or combined as necessary so that part or the whole of the problems described above are so1v ed or part or the whole of the effects described above are achieved. When the technical features are not described as essential features in the present specification, they may be deleted as necessary. For example, part of the configuration realized by hardware in the embodiments may be realized by software.

What is claimed is:

1. A variable volume device comprising:
a bellows that includes a bellows structure portion on a tubular member; and
a coupling port that couples to an internal space of the tubular member to an internal space of a fuel tank;
wherein the bellows structure portion comprises, in a cross section along a central axis of the tubular member:
a first portion which protrudes outward in a radial direction of the tubular member and is formed in an arc shape;
a second portion which is recessed inward in the radial direction relative to the first portion and is formed in an arc shape; and
a coupling portion which makes the first portion couple to the second portion without any singularity, and
a central angle of each of the arc shapes of the first portion and the second portion is greater than 180 degrees.

2. The variable volume device according to claim 1,
wherein the coupling port is provided at one end of the tubular member in the axial direction and a blocking wall is provided at an other end thereof.

3. The variable volume device according to claim 2,
wherein a biasing member which biases the tubular member to a side of an initial position is fitted to the blocking wall.

4. The variable volume device according to claim 1,
wherein the tubular member is formed in a cylindrical shape.

5. The variable volume device according to claim 1,
wherein two or more first portions each being the first portion and two or more second portions each being the second portion are provided.

6. A sealed tank system comprising:
a fuel tank;
a canister which is coupled to the fuel tank by a pipe path to adsorb an evaporated fuel; and
an on-off valve which is provided in the pipe path,
wherein the sealed tank system further comprises the variable volume device according to claim 1, and
the coupling port of the variable volume device is coupled to the pipe path.

7. The sealed tank system according to claim 6,
wherein the variable volume device is arranged such that the coupling port is directed in a vertically downward direction.

8. A sealed tank system comprising:
a fuel tank; and
a fuel supply pipe which couples the fuel tank and a fuel filler opening,
wherein the sealed tank system further comprises the variable volume device according to claim 1, and
the coupling port of the variable volume device is coupled to the fuel supply pipe.

9. The sealed tank system according to claim 8,
wherein the variable volume device is arranged such that the coupling port is directed in a vertically downward direction.

10. A method for manufacturing the bellows used for the variable volume device according to claim 1, the method comprising:
molding the tubular member into a shape in a state where the bellows structure portion is extended;
surrounding a predetermined area including a top of a first portion of the bellows structure portion by an outer ring mold including a concave portion whose cross section along a center axis of the tubular member has an arc shape, the first portion protruding outward in a radial direction;
surrounding a predetermined area including a valley of a second portion of the bellows structure portion by an inner ring mold including a convex portion whose cross section along the center axis of the tubular member has an arc shape, the second portion being recessed inward in the radial direction relative to the first portion;
bringing the tubular member into a plastically deformable first state and compressing the bellows structure portion in a direction in which the outer ring mold and the inner ring mold are moved close to each other; and
bringing the tubular member plastically deformed by the compressing into an elastically deformable second state and extending the bellows structure portion to remove the outer ring mold and the inner ring mold.

11. The method for manufacturing the bellows according to claim 10,
wherein the outer ring mold and the inner ring mold each are divided into a plurality of parts in a circumferential direction.

12. The method for manufacturing the bellows according to claim 11,
wherein the tubular member is formed of a thermoplastic synthetic resin,
the first state is a state where a temperature of the synthetic resin is kept equal to or greater than a temperature at which the synthetic resin is plastic and
the second state is a state where the temperature of the synthetic resin is kept less than the temperature at which the synthetic resin is plastic.

13. The method for manufacturing the bellows according to claim 10,
wherein the tubular member is formed of a thermoplastic synthetic resin,
the first state is a state where a temperature of the synthetic resin is kept equal to or greater than a temperature at which the synthetic resin is plastic and
the second state is a state where the temperature of the synthetic resin is kept less than the temperature at which the synthetic resin is plastic.
